(19) United States
(12) Patent Application Publication
(10) Pub. No.: US 2006/0198602 A1
(43) Pub. Date: Sep. 7, 2006

(54) Stream data recorder

(76) Inventors: Osamu Goto, Osaka (JP); Akira Kitamura, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/363,949

(22) Filed: Mar. 1, 2006

(30) Foreign Application Priority Data
Mar. 4, 2005 (JP) 2005-061554

(51) Int. Cl. H04N 5/91

(52) U.S. Cl. 386/46

(57) ABSTRACT

To record AV data separately in a plurality of recording media, when a disk end detector detects that the free space in a disk runs out, a stream recording location controller accumulates AV data of a stream buffer in a stream shunt memory. When the disk is replaced with a new one, a disk recordability detector detects whether or not the new disk has become recordable. If recordable, a shunted stream write-back section transfers the AV data held in the stream shunt memory to the new disk.

### BACKGROUND OF THE INVENTION

1. Field of the Invention

The present invention relates to a stream data recorder for recording stream data of video, sound, etc., in a recording medium, such as an optical disc (e.g., a removal DVD), a flash memory, or the like, and specifically to a stream data recorder capable of recording a series of stream data of, e.g., a lengthy TV program, over a plurality of recording media.

2. Description of the Prior Art

Conventionally, to continuously record/reproduce a stream data which has a data amount larger than a single recording medium, an autochanger for automatically changing recording media, or the like, is used.

A recording/reproduction device designed in consideration of avoiding loss of data during replacement of recording media has been known wherein the device includes a removable main disk and a sub-disk stored in the device. For example, in this device, data is recorded in the sub-disk in the device during the replacement of the main disk, and data is temporarily accumulated in a buffer memory during a transfer of a pickup (see, for example, Japanese Laid-Open Patent Publication No. 10-106152). In this device, in a recording mode, a recording start address and a recording end address for each disk are stored in an information memory and, in a reproduction mode, data is continuously reproduced according to these addresses.

An AV data recorder which uses a DVD-RAM has been realized wherein smooth and continuous reproduction of AV data is secured by an AV data management file (see, for example, Japanese Laid-Open Patent Publication No. 2002-94945).

In the case where data is recorded in the sub-disk during replacement of the main disk as described above, continuous reproduction is possible so long as the data is reproduced by the recording/reproduction device. However, in the case where the main disk is removed from the recording/reproduction device and the data stored therein is reproduced in another device, there is missing part (which is stored in the sub-disk), which disables continuous reproduction. The same would occur in the device which uses the AV data management file.

### SUMMARY OF THE INVENTION

The present invention was conceived in view of the above circumstances. An objective of the present invention is to reproduce stream data having a large data amount, without any loss of data, using a device different from one used for recording the stream data.

To achieve the above objective, the present invention provides a stream data recorder for recording stream data in a recording medium, comprising: a primary recording section for recording stream data in a removable recording medium; a free space detector for detecting that a free space of a removable first recording medium in which data is being recorded runs out; a shunt recording section for shunting stream data input during replacement of the first recording medium with a removable second recording medium into a shunt recording medium; and a transfer recording controller for instructing the primary recording section to transfer the stream data shunted into the shunt recording medium to the second recording medium.

With the above structure, stream data input during replacement of a recording medium with a new one can be safely recorded in the new recording medium. Therefore, it is readily possible to reproduce the stream data without any data loss using a different device.

In the above stream data recorder, the transfer recording controller may instruct the primary recording medium to record, in the second recording medium, stream data which is input after the replacement with the second recording medium prior to the transfer of the shunted stream data to the second recording medium.

With the above feature, it is readily possible to record the shunted stream data without any restriction on the recording speed, etc.

The primary recording section may record, in the second recording medium, management information indicative of that the shunted stream data is reproduced prior to the stream data which is input after the replacement with the second recording medium.

With the above feature, it is readily possible to reproduce the data in an appropriate order of elapsed time irrespective of the order of recording or the physical arrangement.

The above stream data recorder further comprises a reservation section for reserving in the second recording medium a region in which the shunted stream data is to be recorded, wherein the primary recording section records stream data which is input after the replacement with the second recording medium in a region physically subsequent to the reserved region in the second recording medium.

In this case, the data is recorded in the subsequent region in the order of elapsed time. Therefore, it is readily possible to reproduce the data in an appropriate order of elapsed time.

The primary recording section may record the shunted stream data in a region at a trailing end of a free space in the second recording medium while recording the stream data which is input after the replacement with the second recording medium in a region at the leading end of the free space.

With the above feature, it is readily possible to perform these recording operations independently or in parallel.

Recording of the shunted stream data may be carried out based on a DMA scheme.

With this feature, the processing load on a CPU can readily be decreased.

A plurality of shunt recording media may be used in a predetermined order of priority.

With this feature, the stream data which is input during the replacement of a recording medium can be shunted flexibly while the increase in circuit scale is suppressed.

### BRIEF DESCRIPTION OF THE DRAWINGS

FIG. 1 is a block diagram showing a structure of a video/audio signal recorder 100 according to embodiment 1.

FIG. 2 is a flowchart illustrating an operation of the video/audio signal recorder 100 during recording of AV data according to embodiment 1.

FIG. 3 is a block diagram showing a structure of a video/audio signal recorder 200 according to embodiment 2.

FIG. 4 is a hierarchic illustration of data recorded in an AV data management file 4000 according to embodiment 2.

FIG. 5 illustrates logical linkages between tables and VOBs according to embodiment 2.

FIG. 6 is a hierarchic illustration of the relationships between sectors and ECC blocks in zones according to embodiment 2.

FIG. 7 illustrates management information for a file system and relevant information according to embodiment 2.

FIG. 8 is a flowchart illustrating an operation of the video/audio signal recorder 200 during recording of AV data according to embodiment 2.

FIG. 9 illustrates the contents of the AV data management file 4000 obtained after data from a stream shunt memory 105 has been recorded in a disk 120 according to embodiment 2.

FIG. 10 illustrates an arrangement of AV data recorded in the disk 120 according to embodiment 2.

FIG. 11 illustrates management information for a file system and relevant information recorded in the disk 120 according to embodiment 2.

FIG. 12 is a block diagram showing a structure of a video/audio signal recorder 300 according to embodiment 3.

FIG. 13 is a flowchart illustrating an operation of the video/audio signal recorder 300 during recording of AV data according to embodiment 3.

FIG. 14 illustrates management information for a file system and relevant information according to embodiment 3.

FIG. 15 is a block diagram showing a structure of a video/audio signal recorder 400 according to embodiment 4.

FIG. 16 is a flowchart illustrating an operation of the video/audio signal recorder 400 during recording of AV data according to embodiment 4.

FIG. 17 illustrates a recording sequence according to embodiment 4.

FIG. 18 is a block diagram showing a structure of a video/audio signal recorder 500 according to embodiment 5.

FIG. 19 is a flowchart illustrating an operation of the video/audio signal recorder 500 during recording of AV data according to embodiment 5.

FIG. 20 is a block diagram showing a structure of a video/audio signal recorder 600 according to embodiment 6.

FIG. 21 illustrates an example of a table of shunt memory management information for a plurality of stream shunt memories 105 according to embodiment 6.

FIG. 22 is a flowchart illustrating an operation of the video/audio signal recorder 600 during recording of AV data according to embodiment 6.

### DESCRIPTION OF THE PREFERRED EMBODIMENTS

Hereinafter, embodiments of the present invention will be described with reference to the drawings. It should be noted that, in the embodiments described below, like elements are denoted by like reference numerals, and detailed descriptions thereof are omitted.

### Embodiment 1

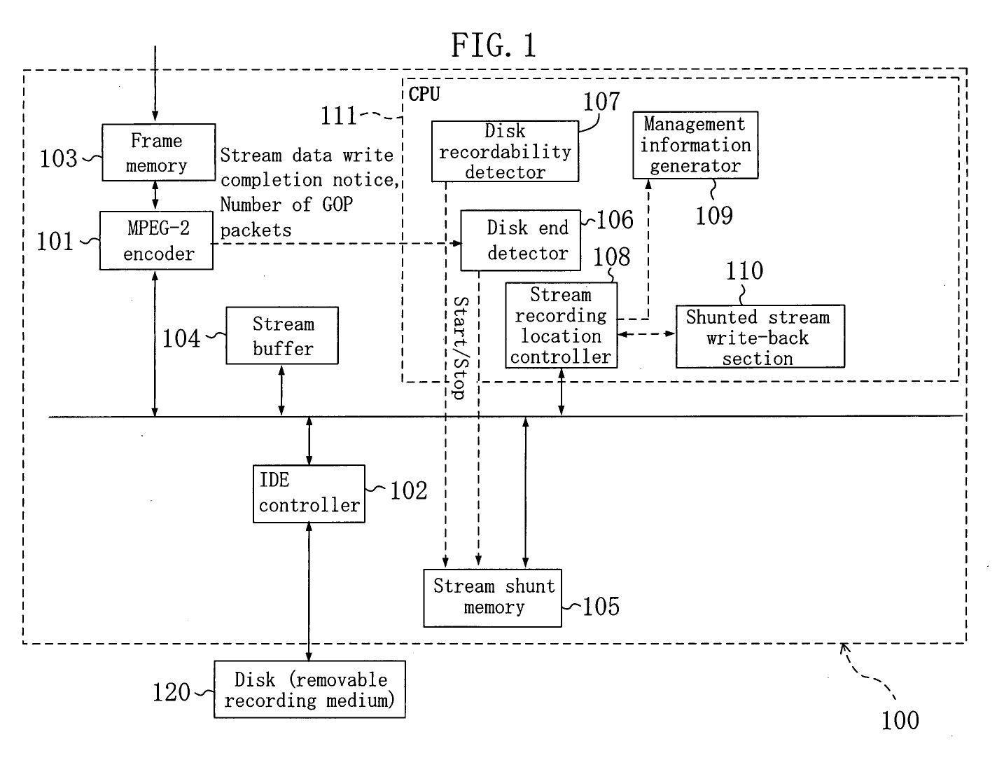

FIG. 1 is a block diagram showing a structure of a video/audio signal recorder 100 according to embodiment 1 of the present invention.

The video/audio signal recorder 100 includes an encoder 101, an IDE controller 102, a frame memory 103, a stream buffer 104, a stream shunt memory 105, and a CPU 111. The video/audio signal recorder 100 records stream data in, for example, a disk 120 which is a removable recording medium.

The encoder 101 compresses video/sound data taken in the frame memory 103 into video and sound packets according to, for example, MPEG-2 (Moving Picture Experts Group-2) and writes resultant video/sound data (AV data) in the stream buffer 104 by the predetermined units, for example, on a GOP by GOP basis, each GOP (Group Of Pictures) having a length of about 0.5 seconds. The CPU 111 is notified about completion of encoding and writing of each GOP (events) by a signal transmitted via a bus or an interruption signal. The CPU 111 reads the AV data written in the stream buffer 104 and writes the read AV data in the disk 120 or stream shunt memory 105. Every time encoding of a GOP (writing of a GOP in the stream buffer 104) is completed, the encoder 101 notifies the CPU 111 about the number of packets of the GOP.

The IDE controller 102 writes AV data in the disk (removable recording medium) 120 through a driver (not shown).

If the free space in the disk 120 has run out, the stream shunt memory 105 stores AV data till replacement of the disk 120 with a new one is completed as will be described later. The stream shunt memory 105 may be any type of storage, for example, a semiconductor memory, a hard disk drive, or the like.

The CPU 111 executes predetermined programs to function as a disk end detector 106, a disk recordability detector 107, a stream recording location controller 108, a management information generator 109, and a shunted stream write-back section 110.

The disk end detector 106 detects that the free space in the disk 120 runs out. Specifically, every time the CPU 111 is notified about the number of packets of a GOP encoded by the encoder 101 as described above, the disk end detector 106 calculates the size of the free space in the disk (for example, the size of a free space in an entire disk or the size of a free space in an area which is reserved for recording AV data) based on the free space in the disk 120 which has been stored in advance.

When the disk 120 is replaced with a new one, the disk recordability detector 107 detects whether or not the new disk 120 becomes recordable.

The stream recording location controller 108 determines in which of the disk 120 and the stream shunt memory 105 the AV data stored in the stream buffer 104 is to be recorded.

At the time of completing recording of AV data in the disk 120 or the stream shunt memory 105, the management information generator 109 generates management information used for reproduction of the AV data, for example, AV data management information indicative of the relationship between the times with predetermined intervals and the addresses of the disk 120 in which AV data for the times are written. The management information is written in an exclusive area different from those reserved for the AV data.

The shunted stream write-back section 110 transfers AV data which has been stored in the stream shunt memory 105 during the replacement of the disk 120, as described above, to the disk 120.

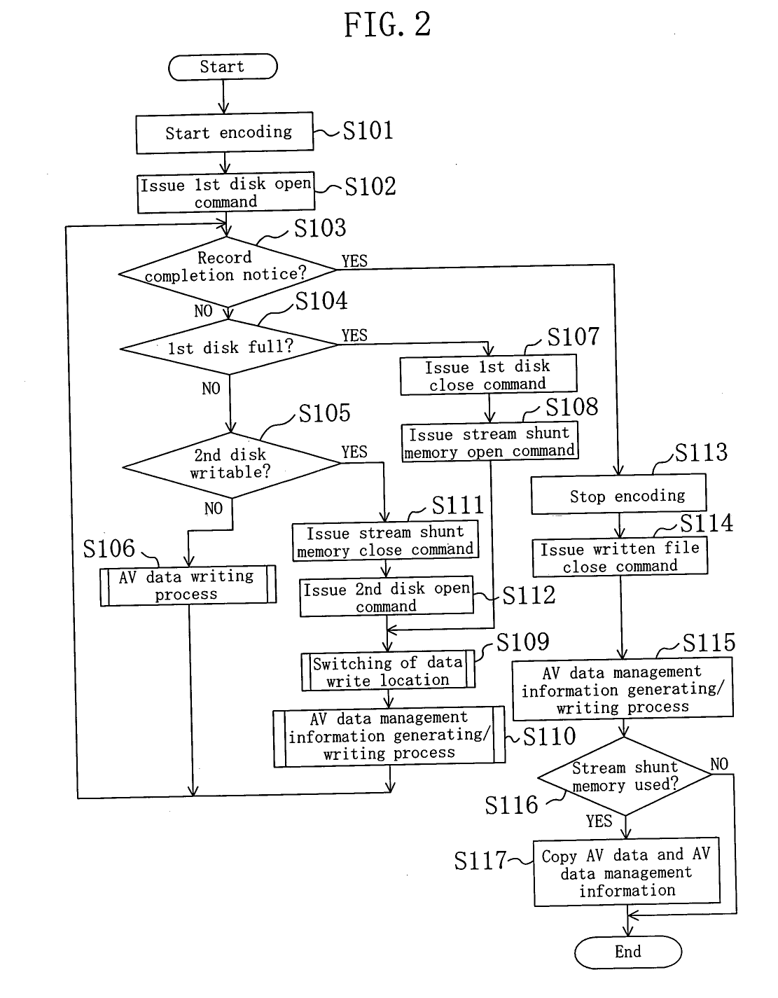

Next, an operation of the video/audio signal recorder 100 having the above structure is described with reference to FIG. 2.

(S101) In response to an event, for example, depression of a recording key (not shown), the CPU 111 instructs the encoder 101 to start encoding.

(S102) An AV data file, which is to be used for writing AV data in the first disk 120, is opened.

(S103) It is determined whether or not a recording completion notice has been issued by, for example, a user's operation. If not issued, the process proceeds to step S104.

(S104) The disk end detector 106 determines whether or not it is immediately after the first disk 120 (in the process of recording) has just become full. If not, the process proceeds to step S105.

(S105) When the first disk 120 becomes full, the disk 120 is replaced with the second one, and the disk recordability detector 107 determines whether or not the second disk 120 becomes writable. If the first disk 120 is not yet full or if the second disk 120 is not writable, the process proceeds to step S106.

(S106) Every time an encoding completion notice for each GOP is issued from the encoder 101, the AV data stored in the stream buffer 104 is written in a recording position indicated by the stream recording location controller 108, specifically, in the first or second disk 120 or in the stream shunt memory 105.

Thereafter, steps S103 to S106 are repeated, whereby the AV data is written in the disk(s) 120.

(S107) If the disk end detector 106 determines at step S104 that it is immediately after the first disk 120 has just become full, the AV data file is first closed.

(S108) A file used for writing AV data in the stream shunt memory 105 is opened. (It should be noted that the recording format in the stream shunt memory 105 is not limited to any particular one. For example, when a file system is not employed, the process of opening the file is not necessary.)

(S109) When the disk 120 in which data is being recorded becomes full, the stream recording location controller 108 switches the location in which the AV data is to be written from the disk 120 (IDE controller 102) to the stream shunt memory 105.

(S110) The management information generator 109 generates AV data management information about AV data recorded in the first disk 120 (or the stream shunt memory 105 during the replacement of the disk 120 as will be described later) and writes the AV data management information in the first disk 120 (or the stream shunt memory 105).

Thereafter, it is monitored whether or not the second disk 120 becomes writable while steps S103 to S106 are repeated to write the AV data in the stream shunt memory 105.

(S111) If the disk recordability detector 107 determines at step S105 that the next disk 120 is writable, the AV data file written in the stream shunt memory 105 is closed.

(S112) A file used for writing AV data in the next disk 120 is opened.

(S109) The stream recording location controller 108 switches the location in which the AV data is to be written from the stream shunt memory 105 to the next disk 120.

(S110) The management information generator 109 generates AV data management information about AV data in the stream shunt memory 105 and stores the AV data management information in the stream shunt memory 105. The AV data management information includes, for example, information indicative of the relationship between the times with predetermined intervals and the addresses of the disk 120 in which data for the times are written. If the addresses are relative addresses with respect to an address of the disk 120 at which the leading end of the AV data of the stream shunt memory 105 is written, for example, the addresses can be determined before the writing is actually started.

Thereafter, steps S103 to S106 are repeated, whereby the AV data is written in the new disk 120.

(S113) If it is determined at step S103 that a recording completion notice has been issued, the encoding is stopped, and the following processes are performed.

(S114) First, the AV data file of the disk 120 in which the AV data has been written is closed.

(S115) The management information generator 109 generates AV data management information about AV data written in the disk 120 and writes the AV data management information in the disk 120.

(S116) It is determined whether or not the stream shunt memory 105 has been used, i.e., whether or not the disk 120 has been replaced. If not, the process is simply ended. If used (replaced), the process proceeds to step S117.

(S117) The shunted stream write-back section 110 transfers the AV data file which has been stored in the stream shunt memory 105 during the replacement of the disk 120 and the AV data management information file to a disk 120 installed in the recorder at this point in time.

As described above, the AV data input during the replacement of the disk 120 is first stored in the stream shunt memory 105 and then written in a new disk 120. Thus, it is readily possible to safely store the entire AV data in a plurality of disks 120.

Although in the above-described example data is recorded over two disks 120, the data can be recorded over three or more disks by repeating the above procedure.

### Embodiment 2

In embodiment 2, an example of a stream data recorder which uses a DVD-RAM as a recording medium and which records stream data using a management scheme based on the DVD-VR standards is described.

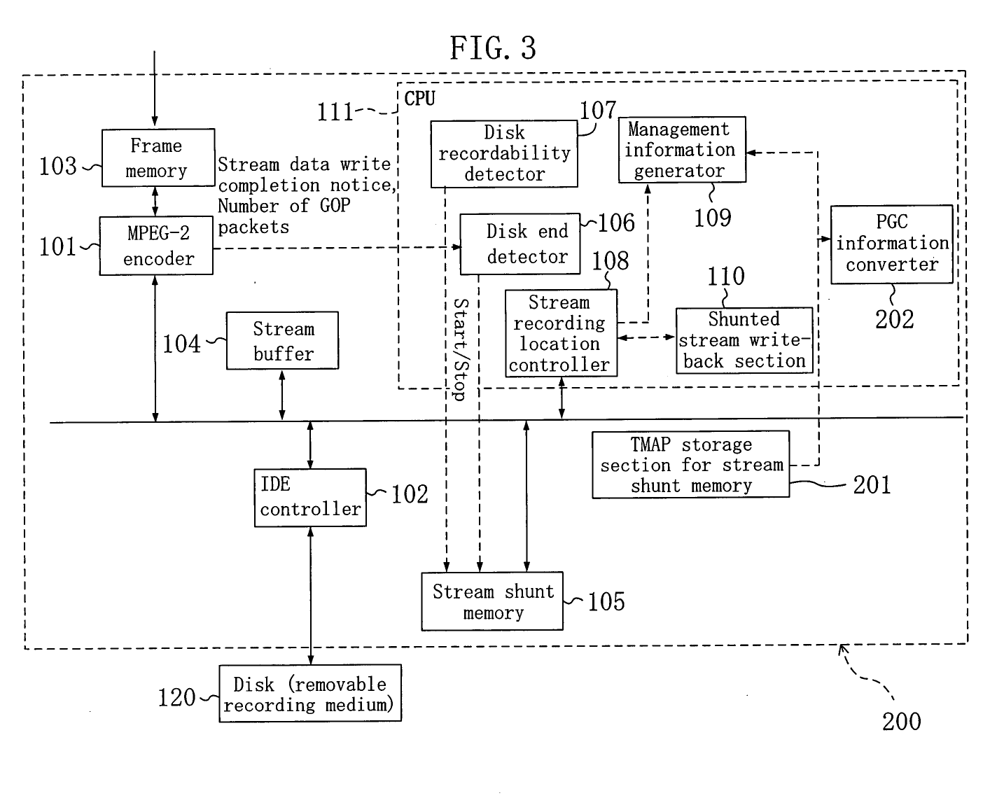

Referring to FIG. 3, a video/audio signal recorder 200 of embodiment 2 includes, in addition to the components of the video/audio signal recorder 100 of embodiment 1, a TMAP storage section 201 for the stream shunt memory 105 and a PGC (program chain) information converter 202. The TMAP storage section 201 may be physically realized by the memory which constitutes the stream shunt memory 105.

A TAMP (time map information) which is stored in the TMAP storage section 201 is a table for converting time code information to address information as described in embodiment 1 as to the AV data management information. In the video/audio signal recorder 200 of embodiment 2, the TAMP is based on the DVD-VR standards.

After AV data and AV data management information stored in the stream shunt memory 105 has been transferred to a disk 120 at the time of completion of recording, the PGC information converter 202 converts PGC information included in the AV data management information such that the AV data can be reproduced in a correct order. Details of conversion of the PGC information will be described later.

Now, a management structure of AV data recorded in the disk 120 by the video/audio signal recorder 200 of embodiment 2 is described on the assumption that the DVD-VR standards are employed.

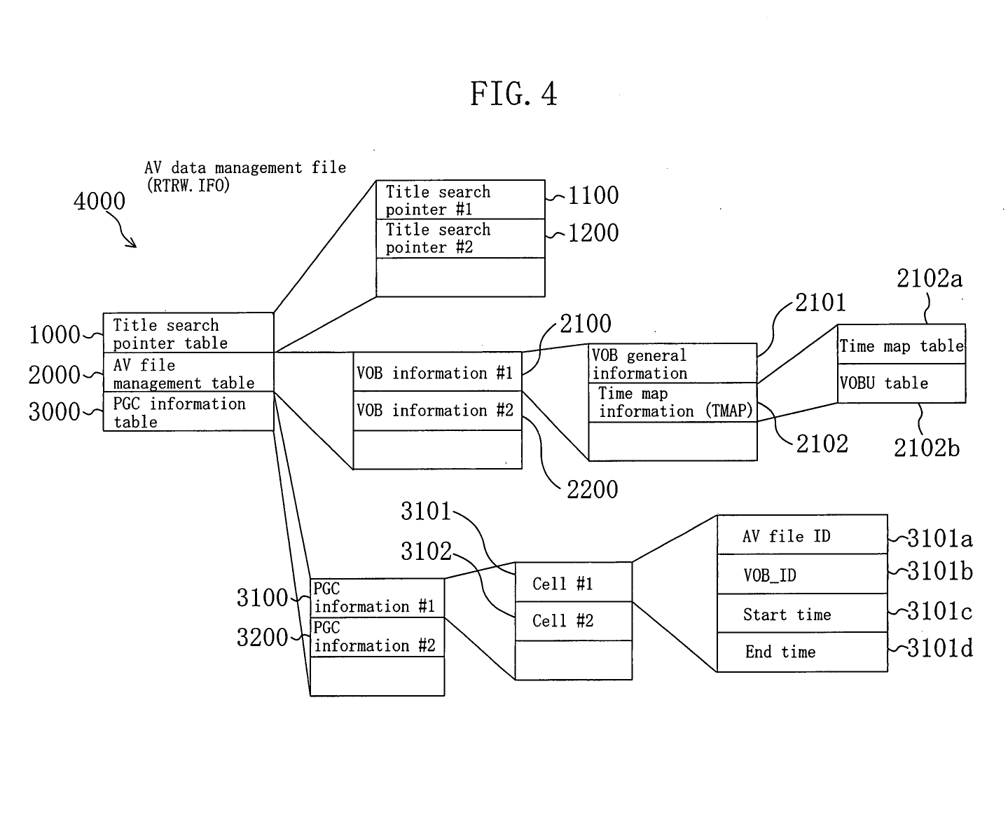

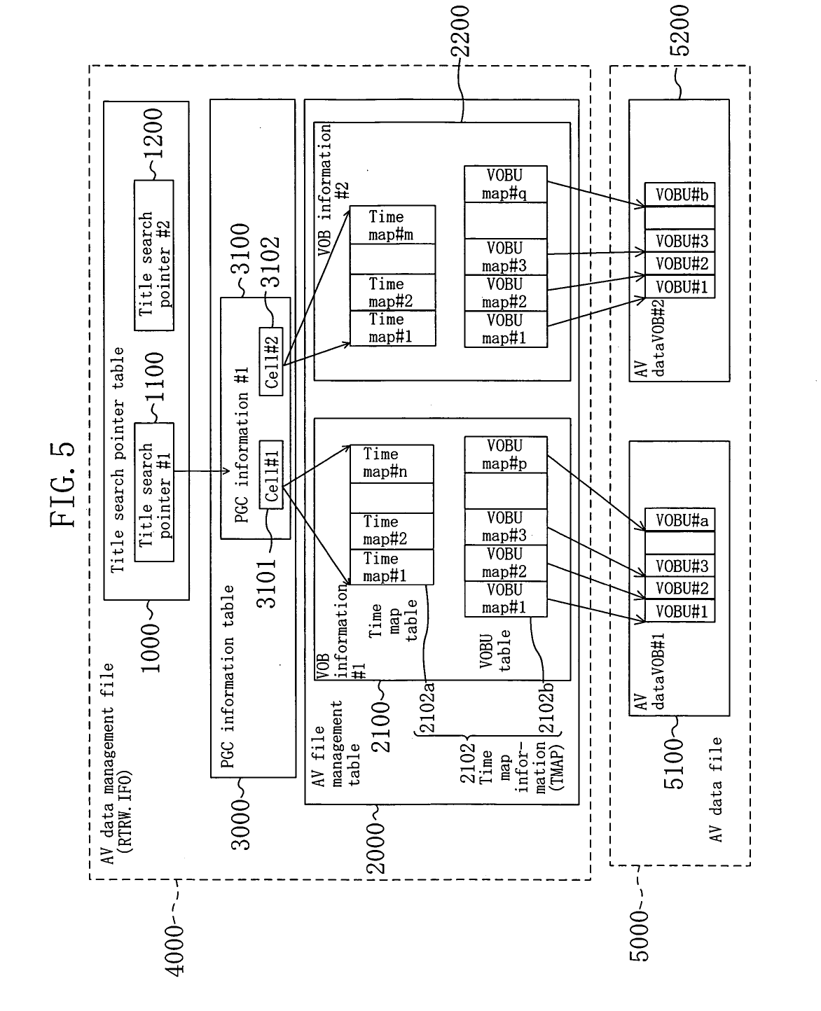

FIG. 4 is a hierarchic illustration of data recorded in an AV data management file 4000 (RTRW.IFO). FIG. 5 illustrates logical linkages between the tables and VOBs (Video Objects).

The AV data management file 4000 has a title search pointer table 1000, an AV file management table 2000, and a PGC information table 3000.

The title search pointer table 1000 is a table which includes a list of titles recorded in a DVD-RAM. The title is, for example, a title attached to a program that a user recorded in the recorder or a title editorially generated by the user. Title search pointers (1100, 1200, . . . ) included in the title search pointer table 1000 points at PGC information 3100 in the PGC information table 3000 which correspond to the titles. Herein, a PGC means a series of AV data formed by logically-linked segments of VOB. The PGC information 3100 is information indicative of logical linkage between segments of VOB.

The AV file management table 2000 is information which represents the relationship between the play times and the recording positions of VOBs in an AV data file. In the AV file management table 2000, a number of VOB information (2100, 2200, . . . ) which is the same as the number of VOBs are recorded. Each of the VOB information (2100, 2200, . . . ) includes VOB general information 2101 (not shown in FIG. 5) indicative of information inherent to a VOB, e.g., the play length, and time map information 2102 (TMAP) which associates the play times of a VOB and the recording positions. The VOB general information 2101 includes a VOB identifier indicative of to which VOB the VOB information corresponds, the play length of the corresponding VOB, etc. The time map information 2102 includes a time map table 2102a (first time table) and a VOBU table 2102b (second time table). The time map table 2102a includes time maps (time map #1, time map #2, . . . ). Each of the time maps indicates the relative recording positions (sector addresses) with respect to the leading end of the VOB of a VOBU (Video Object Unit) which correspond to the play times with predetermined intervals where the play start time corresponds to the leading end of the VOB. The VOBU table 2102b includes VOBU maps (VOBU map #1, VOBU map #2, . . . ). Each of the VOBU maps indicates the play time and data size of each VOBU in the order of the play times from the leading end of a VOB.

The PGC information table 3000 includes a plurality of pieces of PGC information (3100, 3200, . . . ). The PGC information (3100, 3200, . . . ) is a table where information indicative of video segments which are designated by combination of the start time and the end time (referred to as “cell(s)”) in a VOB are arranged in the order of play time. The PGC information represents a series of AV data obtained by logically linking the video sections indicated in the cells (3101, 3102, . . . ) in the order of arrangement. Each of the cells (3101, 3102, . . . ) includes, in the form of a pointer, an ID (identifier) of each time map table 2102a in the VOB information (2100, 2200, . . . ) in the AV file management table 2000. The ID is converted as will be described later such that reproduction is readily carried out in an appropriate order.

Next, an example of physical arrangement of AV data (including AV data management information) recorded in the disk 120 (DVD-RAM) is described.

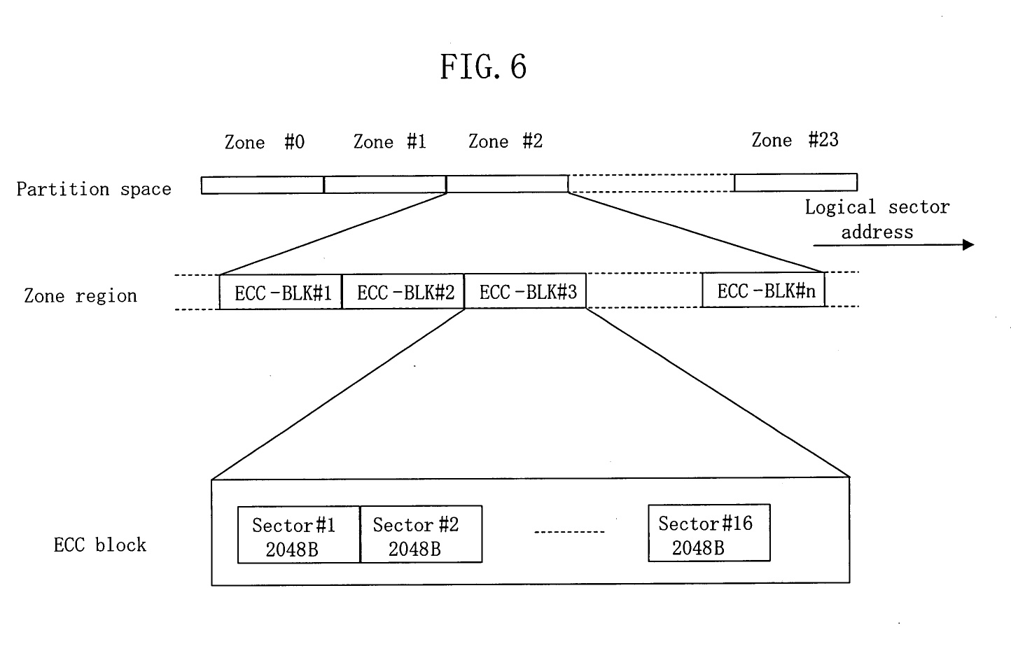

FIG. 6 is a hierarchic illustration of the relationships between sectors and ECC blocks in a zone. As shown in FIG. 6, each zone includes a plurality of ECC blocks. At the time of recording in the disk 120, one or more continuous recording regions, each sufficient for securing continuous reproduction, are allocated to AV data, whereas recording regions are allocated to non-AV data (AV data management information, etc.) on a sector-by-sector basis. Herein, the continuous recording region means a series of consecutive sectors having a certain size (e.g., about 7 Mbytes) or more as a whole, which is N times the ECC block (N is an integer) and which does not overstep a boundary of zones.

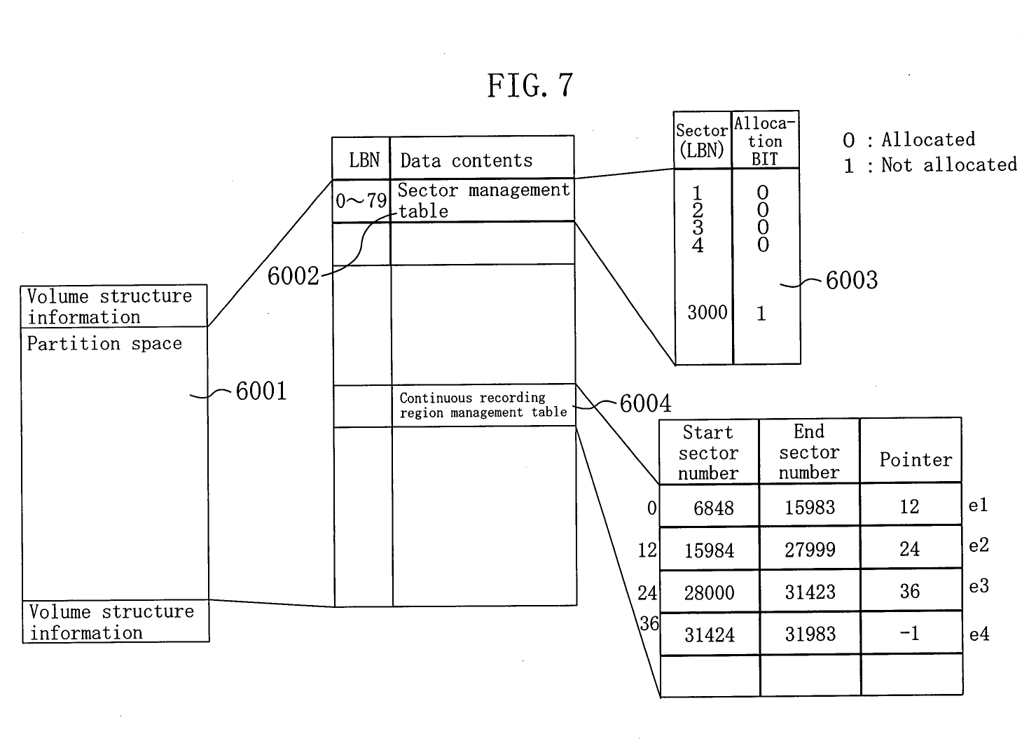

FIG. 7 shows a sector management table 6002 included in management information for a file system and a continuous recording region management table 6004 for managing the continuous recording regions, which are recorded in a volume space. The first layer (left) shows a volume space which includes a partition space 6001. The second layer (center) shows a sector region in the partition space 6001, in which the sector management table 6002, the continuous recording region management table 6004, etc., are recorded.

In a sector region of logical blocks Nos. 0 to 79, a sector management table 6002 which shows the data allocation status for each sector is recorded.

As shown in the third layer (right), a space bit map 6003 shows, as to all of the sectors in the partition space, whether or not each sector has been allocated. In this example, the space bit map 6003 is such that the allocation status (allocated or not allocated) of one sector is expressed by one bit. For example, the blocks of logical block Nos. 0 to 79 are allocated to the space bit map 6003 itself, so that the bits corresponding to these blocks are “0 (allocated)”.

The continuous recording region management table 6004 is recorded as a non-AV file. Therefore, the continuous recording region management table 6004 is not recorded in a fixed region but in any free space in the disk 120 as a normal file.

As shown in the third layer, the continuous recording region management table 6004 shows regions which have already been allocated as the continuous recording regions in the partition space 6001. In FIG. 7, the continuous recording region management table 6004 has a list structure including entries (entry e1, entry e2, . . . ). At the left outside of the table, relative addresses from the head of the table (number of bytes) are affixed. Each entry consists of, from the left of FIG. 7, a start sector number (LSN), an end sector number, and a pointer. The region in the disk 120 between the start sector number and the end sector number in each entry represents a sector region which is allocated to a part of continuously-recorded data or a whole piece of continuously-recorded data. The pointer points at an entry indicative of a subsequent continuous recording region, which is expressed by a relative address numbered from the head of the table. The pointer of the last entry e4 is a value indicative of the trailing end (−1). Specifically, in the example of FIG. 7, entry e1 indicates that the sectors Nos. 6848 to 15983 constitute a continuous recording region, and that the entry of the subsequent continuous region is entry e2 which starts from the 12th byte. The same applies to the other entries. A single continuous region indicated by entries e1 to e4 (6848 to 31983) is a result of, for example, a case where AV data is recorded through four separate operations while continuous recording regions are sequentially added. Allocation of the continuous recording regions and the space bit map are managed in conjunction with each other. For example, the allocation status of a region allocated as a continuous region is also changed to “allocated” in the space bit map.

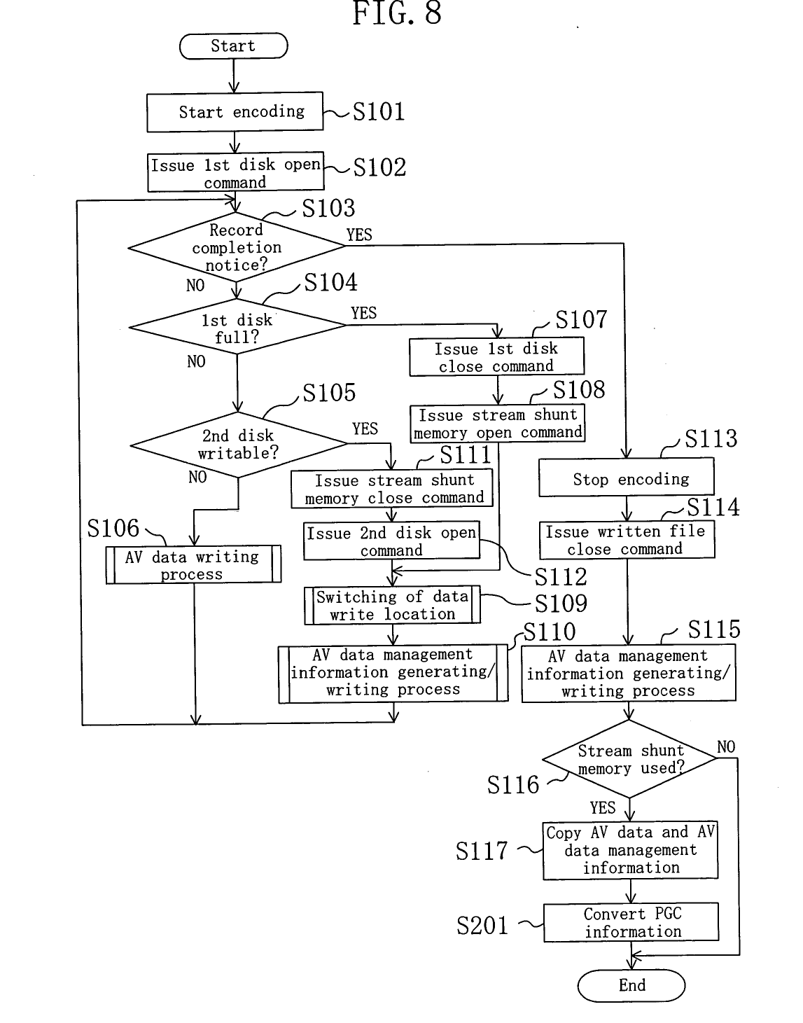

Next, an operation of the video/audio signal recorder 200 having the above structure is described. Referring to FIG. 8, the operation of the video/audio signal recorder 200 is different from the video/audio signal recorder 100 of embodiment 1 (FIG. 2) only in that step S201 is additionally carried out after step S117.

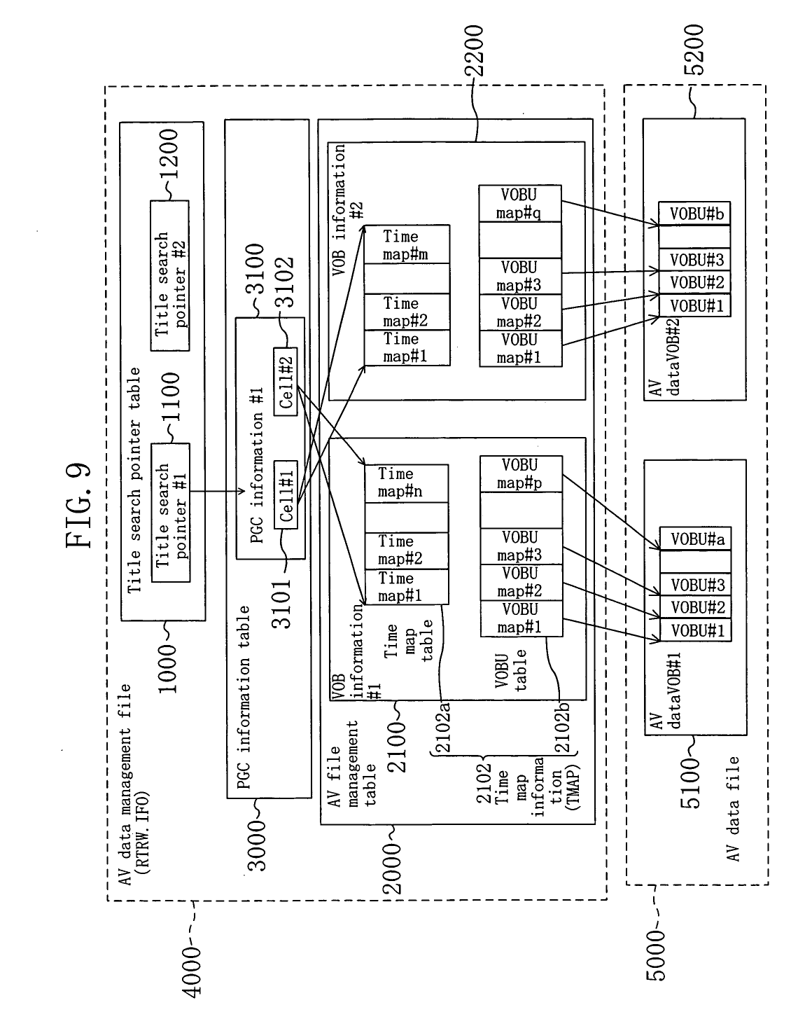

For example, it is determined at step S103 that a record completion notice has been issued, and the recording operation is stopped. At step S116, it is determined that the stream shunt memory 105 has been used (i.e., the disk 120 has been replaced). At step S117, an AV data file stored in the stream shunt memory 105 and AV data management information including TMAP stored in the TMAP storage section 201 are transferred to and recorded (copied) in the disk 120. Thereafter, at step S201, the PGC information converter 202 converts PGC information such that the AV data can be reproduced in an appropriate order. More specifically, for example, as shown in FIG. 9, the PGC information 3100 (PGC information #1) is generated (converted) such that the ID of VOB information 2200 (VOB information #2) of the AV data copied from the stream shunt memory 105 is associated with the cell 3101 (cell #1) of the PGC information 3100 in the AV data management file 4000, and the ID of VOB information 2100 (VOB information #1) of the AV data directly written in the second disk 120 is associated with the cell 3102 (cell #2).

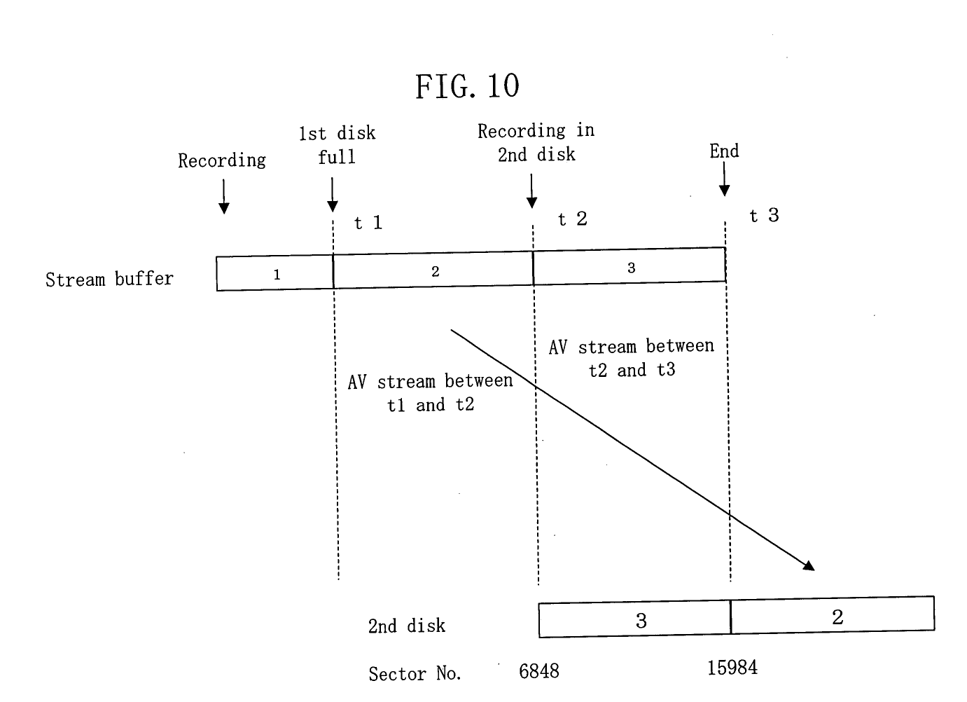

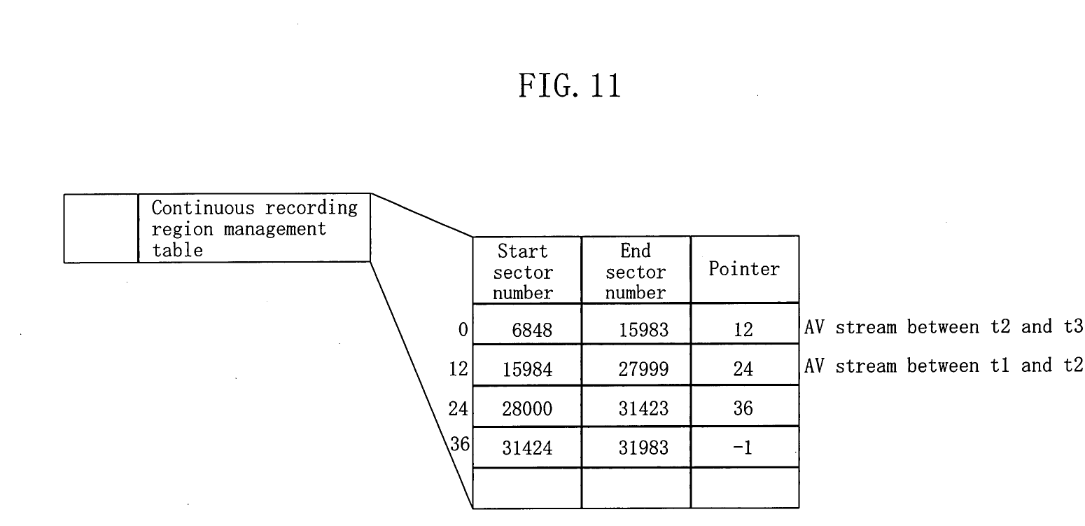

Thus, if the AV data is reproduced in the order of the cell 3101 (cell #1) and the cell 3102 (cell #2), the AV data is reproduced in an appropriate time order. For example, as shown in FIG. 10 and FIG. 11, after the first disk 120 has become full at time t1, the AV data is directly recorded in the second disk 120. The recording regions of the AV data in respective periods are as shown in FIG. 10 and FIG. 11. Although the physical arrangement order is different from that of an original stream data, the AV data can be reproduced in an appropriate order due to the AV data management file 4000 generated as described above.

### Embodiment 3

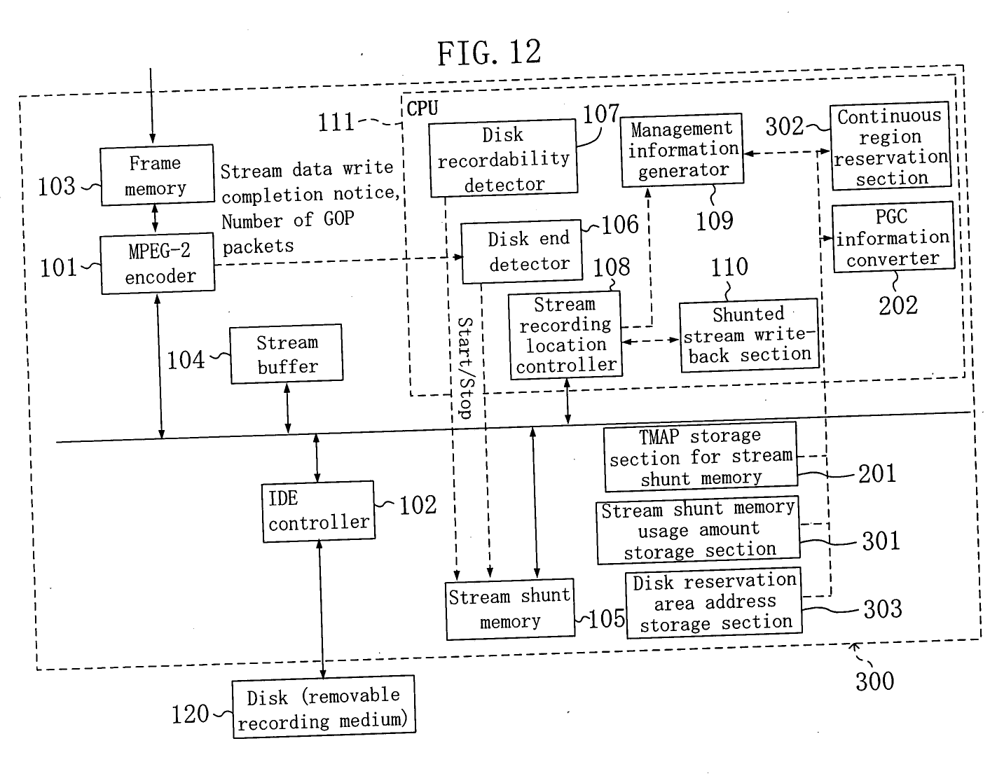

Referring to FIG. 12, a video/audio signal recorder 300 of embodiment 3 includes, in addition to the components of the video/audio signal recorder 200 of embodiment 2, a stream shunt memory usage amount storage section 301, a continuous region reservation section 302, and a disk reservation area address storage section 303.

The stream shunt memory usage amount storage section 301 stores the data amount of AV data stored in the stream shunt memory 105 during the replacement of the disk 120. The method for calculating the data amount is not limited to any particular method. For example, the data amount may be the difference in address between the start and end of the storage in the stream shunt memory 105.

At the time of starting recording in the second disk 120, the continuous region reservation section 302 reserves a continuous region capable of accommodating an amount of data recorded in the stream shunt memory 105 as a reserved region.

The disk reservation area address storage section 303 stores the leading address of the reserved continuous region.

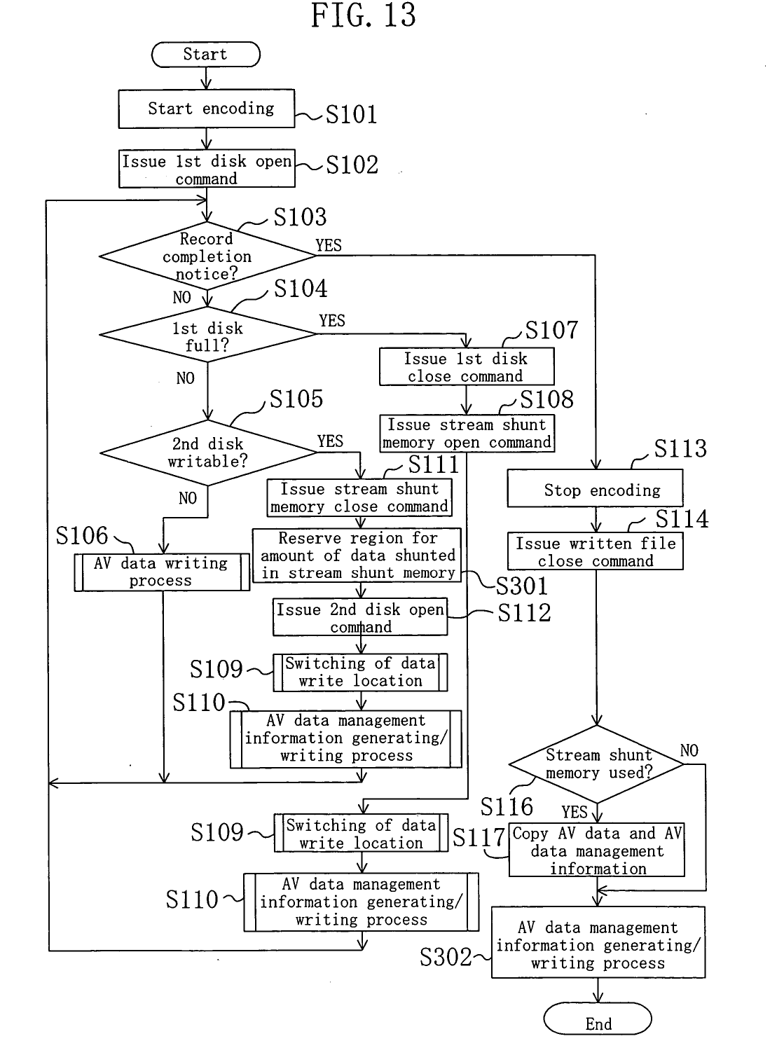

In the video/audio signal recorder 300, referring to FIG. 13, step S301 is carried out after step S111 of embodiment 2 (FIG. 8), and step S302 is carried out in place of step S201 and step S115 of embodiment 2.

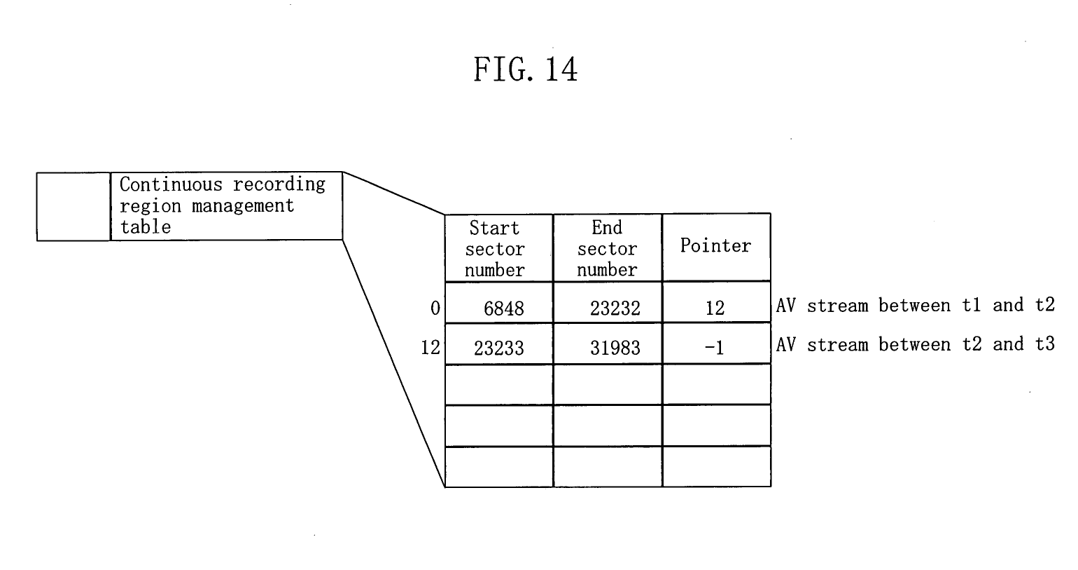

As described in embodiment 1, it is determined at step S105 that the new disk 120 replaced has become writable. At step S111, an AV data file written in the stream shunt memory 105 is closed. Thereafter, at step S301, the amount of the used space in the stream shunt memory 105 is calculated and stored in the stream shunt memory usage amount storage section 301. Then, at the start of recording in the second disk 120, a continuous recording region is allocated according to the amount of the used space in the stream shunt memory 105. Specifically, for example, as shown in FIG. 14, when a region of 32 MB in the stream shunt memory 105 is occupied by AV data, a regions of 16 K sectors, corresponding to start sector numbers 6848 to 23232, is reserved. Start sector number 6848 is stored in the disk reservation area address storage section 303. Writing of AV data is started from sector 23233 which is immediately subsequent to the reserved region. The AV data file which has been stored in the stream shunt memory 105 at the time of stopping the recording operation in response to the recording completion notice is copied to a region starting from start sector number 6848.

At step S302, for example, the PGC information 3100 in the AV data management file 4000 is generated such that the AV data is read from the region of sector numbers 6848 to 23232 and the region of sector numbers 23233 to 31983 in this order, and recorded in the disk 120. (More specifically, for example, a TMAP of AV data recorded in the second disk 120 in a realtime manner is generated by shifting the address of a VOBU by the amount of data shunted to the shunt memory. The PGC information is generated such that one cell corresponds to AV data recorded in the region of sector numbers 6848 to 31983.) That is, the AV data is recorded such that the AV data can be reproduced in the order of physical arrangement of the disk 120.

When a region is reserved as described above, the AV information of the stream shunt memory 105 and the AV information of the second disk 120 can be combined into one VOB. By doing so, continuous reproduction of two streams is realized as if they had been recorded through a single recording operation even when the two streams are reproduced by a general reproduction device which cannot interpret AV stream management information generated in the recorder of embodiment 2 (management information similar to that obtained when the start and stop of recording are repeated so that two VOBs are generated). (It should be noted that, alternatively, a VOB may be divided into pieces which are then separately recorded even when a region is reserved as described above.)

The present invention is not limited to an example where stream data newly input and encoded after the replacement of the disk 120 and the AV data stored in the stream shunt memory 105 are recorded in a region reserved as described above and a region subsequent to the reserved region. For example, the new stream data and the AV data may be recorded in the leading-end and trailing-end parts of a free space in the second disk 120. In this case, a recording region can readily be secured without the above-described reservation process.

### Embodiment 4

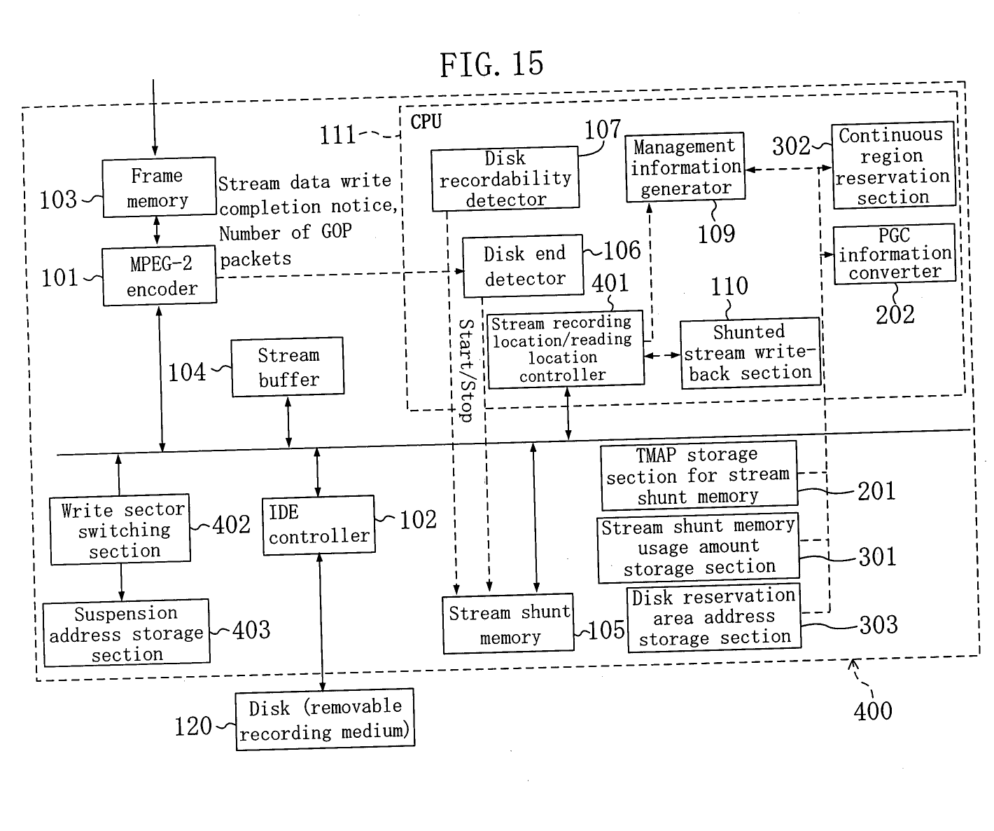

Referring to FIG. 15, a video/audio signal recorder 400 of embodiment 4 has the same structure as that of the video/audio signal recorder 300 of embodiment 3 except that the recorder 400 includes a stream recording location/reading location controller 401 in place of the stream recording location controller 108, a write sector switching section 402, and a suspension address storage section 403. The stream recording location/reading location controller 401 switches the transfer origin and transfer destination of AV data. The write sector switching section 402 switches a write sector in synchronization with the switching of the transfer origin. The suspension address storage section 403 stores the last address written before the switching.

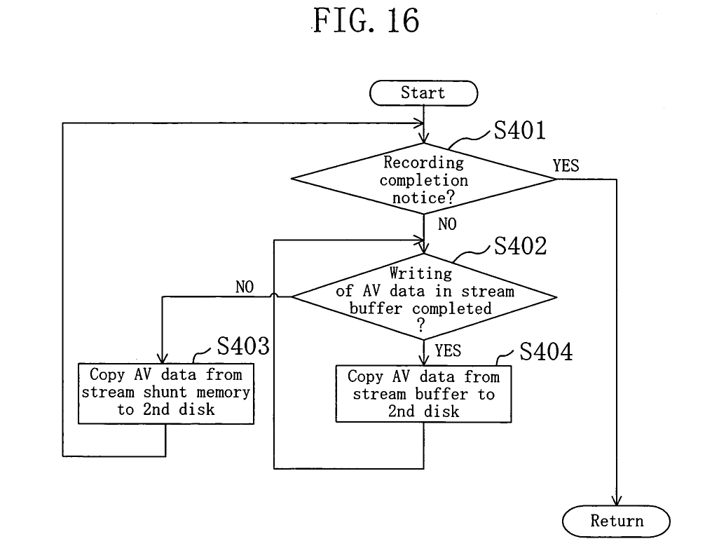

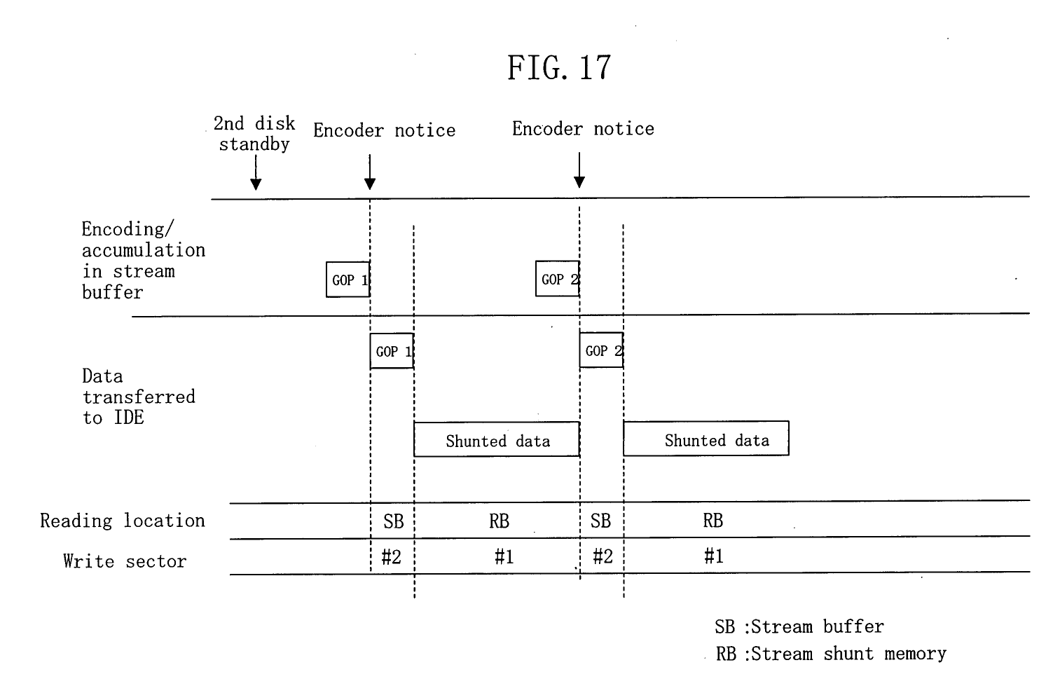

In the video/audio signal recorder 400, as illustrated in FIG. 16 and FIG. 17, after the replacement of the disk 120, AV data stored in the stream shunt memory 105 is written in the disk 120 in parallel with the writing of AV data newly encoded and stored in the stream buffer 104 in the disk 120.

(S401) It is determined whether or not a recording completion notice has been issued by, for example, a user's operation. If issued, the process returns to the main routine to perform an encoding end process and other relevant processes. If not issued, the process proceeds to step S402.

(S402) It is determined whether or not the encoder 101 has completed the GOP-by-GOP encoding, for example, to give a notice to the CPU 111. If no notice, the process proceeds to step S403. If a notice has been given, the process proceeds to step S404.

(S403) If the GOP-by-GOP encoding has not been completed, the stream recording location/reading location controller 401 sets the reading location of AV data (the location from which AV data is to be read) to a region of an address in the stream shunt memory 105 which is indicated by the suspension address storage section 403 and, meanwhile, instructs the IDE controller 102 to set the recording location of AV data (the location in which AV data is to be recorded) to a sector of a shunted AV data write region in the disk 120 which is indicated by the write sector switching section 402. Then, the shunted AV data is transferred to and written in the disk 120. When the transfer of a predetermined amount of shunted AV data has been completed, the suspension address storage section 403 and the write sector switching section 402 store the read address and the write sector at this point in time. When there is no AV data stored in the stream shunt memory 105, i.e., when the first disk 120 is in the recorder or when the transfer of the AV data shunted during the replacement of the disk 120 has been completed although the second disk 120 is in the recorder, the process just returns to step S401 without doing anything.

(S404) If the GOP-by-GOP encoding has been completed, the stream recording location/reading location controller 401 sets the reading location of AV data to a region of an address in the stream buffer 104 which is indicated by the suspension address storage section 403 and, meanwhile, instructs the IDE controller 102 to set the recording location of AV data to a sector of a region in the disk 120 in which a newly-encoded AV data is to be written, the sector being indicated by the write sector switching section 402. Then, the encoded AV data is transferred to and written in the disk 120. When the GOP-by-GOP transfer of the AV data has been completed, the suspension address storage section 403 and the write sector switching section 402 store the read address and the write sector at this point in time.

The present invention is not limited to the writing of data based on the above-described determinations. For example, a writing process may be carried out in an event-driven fashion every time an interrupt occurs.

### Embodiment 5

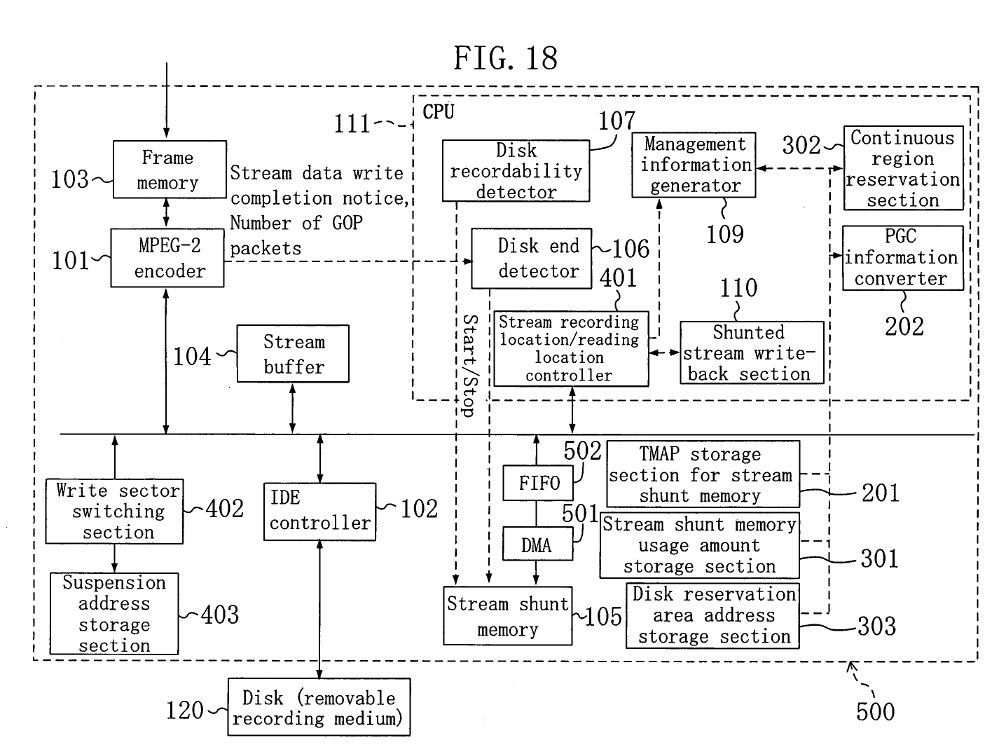

Referring to FIG. 18, a video/audio signal recorder 500 of embodiment 5 includes, in addition to the components of the video/audio signal recorder 400 of embodiment 4, a DMA (Direct Memory Access) circuit 501 and a FIFO (First-In First-Out) buffer 502. Through these components, the data of the stream shunt memory 105 can be transferred.

The DMA circuit 501 reads the AV data stored in the stream shunt memory 105 without the intervention of the CPU 111 and transfers the read data to the IDE controller 102.

By deactivating the FIFO buffer 502, the AV data accumulated in the stream buffer 104 can be transferred to the IDE controller 102 on a priority basis. It should be noted that the FIFO buffer 502 is not necessarily provided. In such a case, the operation of the DMA circuit 501 may be controlled by any other means.

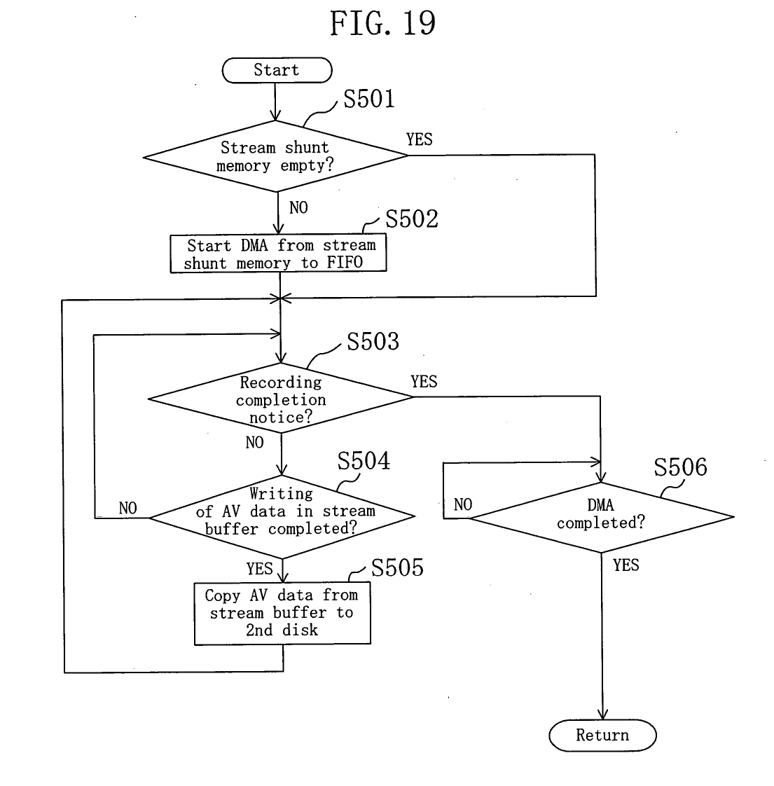

The video/audio signal recorder 500 performs the operation illustrated in FIG. 19 after the replacement of the disk 120.

(S501) It is determined whether or not the stream shunt memory 105 is empty. If empty, the process skips step S502 and proceeds to step S503.

(S502) If it is determined at step S501 that the stream shunt memory 105 is not empty, the start and end addresses of a region in which the AV data is stored are set in the DMA circuit 501, and DMA transfer is started. The AV data stored in the stream shunt memory 105 is transferred to the FIFO buffer 502 and then written in the disk 120.

(S503) It is determined whether or not a recording completion notice has been issued by, for example, a user's operation. If issued, the process proceeds to step S506. If not issued, the process proceeds to step S504.

(S504) It is determined whether or not the encoder 101 has stopped the GOP-by-GOP encoding, for example, to notify the CPU 111 about the completion of writing in the stream buffer 104. If not notified, the process returns to step S503, and the determination processes at step S503 and step S504 are repeated. If notified, the process proceeds to step S505.

(S505) After the FIFO buffer 502 has been deactivated to stop the DMA transfer from the stream shunt memory 105 to the IDE controller 102, the stream recording location/reading location controller 401 sets the reading location of AV data to a region of an address in the stream buffer 104 which is indicated by the suspension address storage section 403 and, meanwhile, instructs the IDE controller 102 to set the recording location of AV data to a sector of a region in the disk 120 in which a newly-encoded AV data is to be written, the sector being indicated by the write sector switching section 402. Then, the encoded AV data is transferred to and written in the disk 120. When the GOP-by-GOP transfer of the AV data has been completed, the suspension address storage section 403 and the write sector switching section 402 store the read address and the write sector at this point in time. Further, a sector of the shunted AV data write region which is indicated by the disk reservation area address storage section 303 (or the write sector switching section 402) is set in the IDE controller 102. The FIFO buffer 502 is activated to carry out the DMA transfer so that the AV data from the stream shunt memory 105 is written in the IDE controller 102. Then, the process returns to step S503, and steps S503, S504 and S505 are repeated.

(S506) If it is determined at step S503 that a recording completion notice has been issued by, for example, a user's operation, the status of the DMA transfer is monitored to repeatedly determine whether or not transfer of the AV data from the stream shunt memory 105 has been completed. If completed, the process returns to the main routine to perform an encoding end process and other relevant processes.

### Embodiment 6

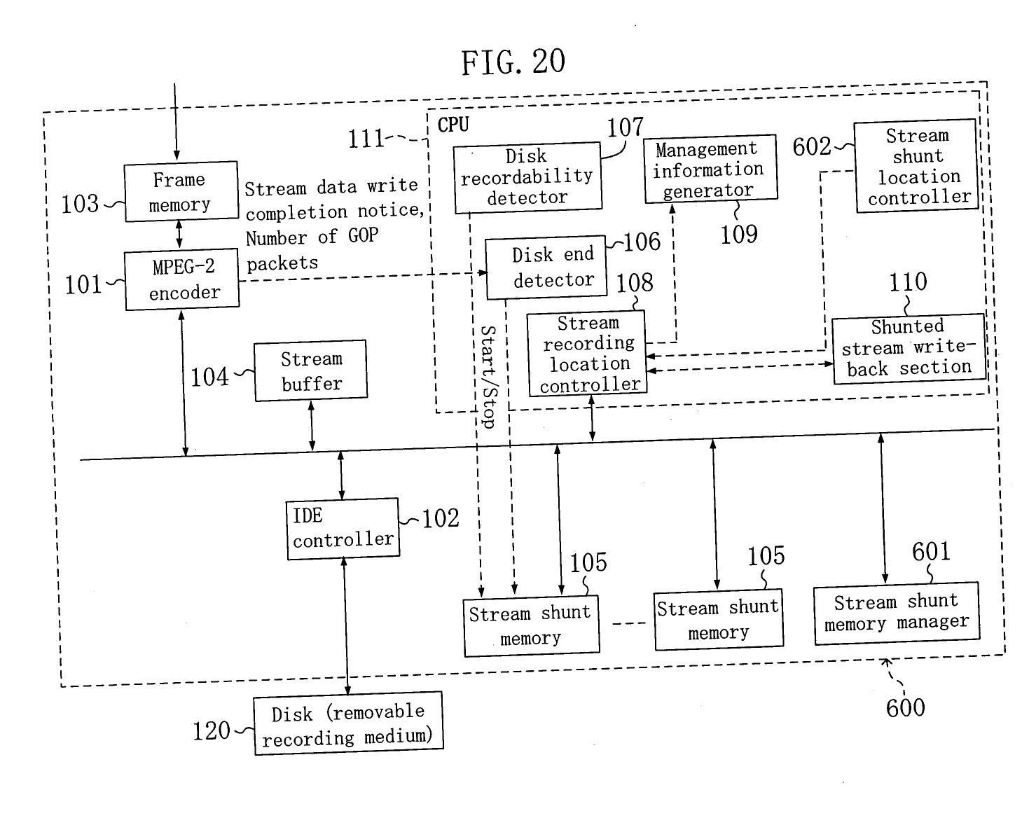

Referring to FIG. 20, a video/audio signal recorder 600 of embodiment 6 has the same structure as that of the video/audio signal recorder 100 of embodiment 1 except that the video/audio signal recorder 600 includes a plurality of stream shunt memories 105. Each stream shunt memory 105 is not limited to any particular recording medium but may be realized by any one of various general recording media including, for example, a removable medium, such as an optical disc, flash memory, and the like, an unremovable medium, such as a hard disk, and the like, a memory like an SDRAM used for controlling software, etc. The stream shunt memory 105 may not be an exclusive memory for shunted AV data but may be a general memory used for various other purposes at the same time. In some particular products, or in some particular use statuses of a product, a memory unused or a memory having a continuous free space may be used, if present, as the stream shunt memory 105.

The video/audio signal recorder 600 further includes a stream shunt memory manager 601 for managing (retaining) shunt memory management information indicative of the priority of use among the plurality of stream shunt memories 105 and a stream shunt location controller 602 for determining the stream shunt memory 105 in which AV data is to be stored based on the shunt memory management information.

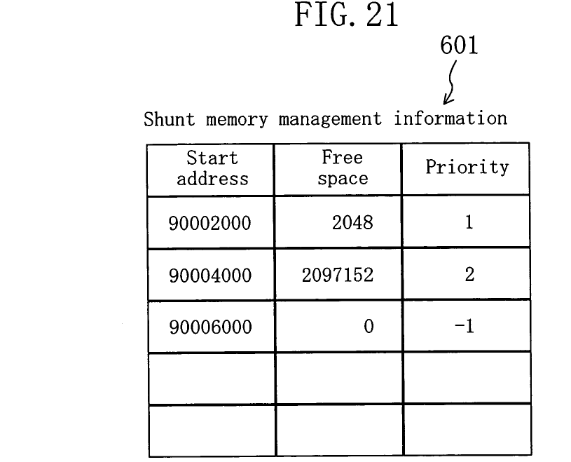

The shunt memory management information is, specifically as shown in FIG. 21, for example, a table showing the relationships of the start address indicative of a leading memory region in the stream shunt memory 105, the free space size, and the priority.

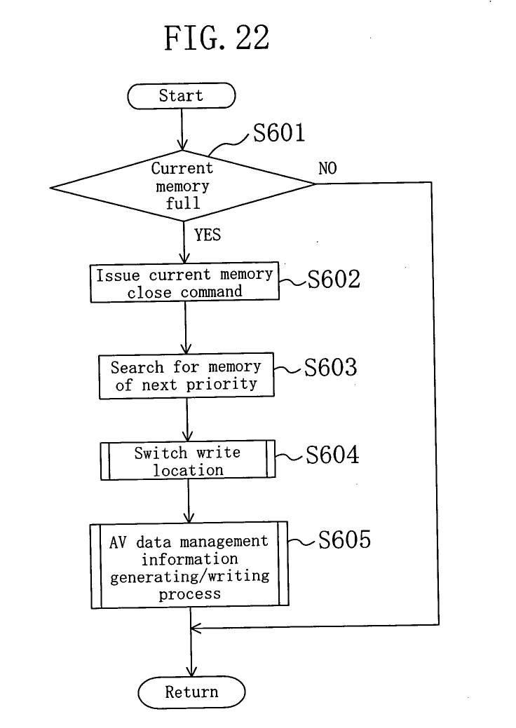

In the video/audio signal recorder 600, when the trailing end of the first disk 120 is detected, the stream shunt memory manager 601 is referred to, and a stream shunt memory 105 with the highest priority is selected. The start address of the selected stream shunt memory 105 is set to the transfer destination. Till the second disk 120 becomes recordable, the process of FIG. 22 is performed every time data is written in the stream shunt memory 105.

(S601) When the encoder 101 completes the GOP-by-GOP encoding, for example, to notify the CPU 111 about the completion of writing in the stream buffer 104, the size of the remaining free space in the (current) stream shunt memory 105 which is currently used is calculated to check whether or not the stream shunt memory 105 has a free space (full or not). If not full, the writing of data in the stream shunt memory 105 is continued.

(S602) When the free space in the stream shunt memory 105 runs out before the second disk 120 becomes recordable, the AV data file written in the stream shunt memory 105 is closed.

(S603) The stream shunt location controller 602 refers to the stream shunt memory manager 601 to search for the stream shunt memory 105 of the next priority.

(S604) The start address of the found stream shunt memory 105 is set to the transfer destination, and the write location of the AV data from the stream buffer 104 (the location in which the AV data from the stream buffer 104 is written) is switched. In this case, for example, the priority and free space size of the stream shunt memory 105 which is full of data is updated to “−1” and “0”, respectively, so that the stream shunt memory 105 is prohibited to be used thereafter.

(S605) An AV data management file and relevant data are generated and recorded in the stream shunt memory 105 before switched to another.

When the next disk 120 becomes recordable while the AV data are in the process of shunting as described above (or after completion of recording has been instructed), the shunted data are written in the disk 120 in the same order of priority as that of the shunting. For example, when the DVD-VR standards are followed as described in embodiment 2, a VOB(s) and an AV data management file of each stream shunt memory 105 are recorded in the disk 120. The AV data management file is generated at the time of generating PGC information such that the cells (cell#1, cell#2, . . . ) correspond to VOBs shunted to the stream shunt memories 105 in the order of priority: specifically, cell#1 corresponds to the stream shunt memories 105 of the highest priority; cell#2 corresponds to the stream shunt memories 105 of the second highest priority; the same applies to the subsequent cells; and the last cell corresponds to a VOB directly recorded in the disk 120. Herein, if, as to the stream shunt memories 105 used, the value of priority which is stored in the stream shunt memory manager 601 is changed to “−1”, the value of priority for writing data in the disk 120 may be stored separately. Alternatively, the values of priority and free space size are not changed to “−1” or “0”, and information indicative of that the memory 105 has been used may be added separately.

As described above, according to the present invention, stream data having a large data amount can be reproduced, without any loss of data, even with a device different from one used for recording the stream data.

What is claimed is:

1. A stream data recorder for recording stream data in a recording medium, comprising:
a primary recording section for recording stream data in a removable recording medium;
a free space detector for detecting that a free space of a removable first recording medium in which data is being recorded runs out;
a shunt recording section for shunting stream data input during replacement of the first recording medium with a removable second recording medium into a shunt recording medium; and
a transfer recording controller for instructing the primary recording section to transfer the stream data shunted into the shunt recording medium to the second recording medium.

2. The stream data recorder of claim 1, wherein the transfer recording controller instructs the primary recording medium to record, in the second recording medium, stream data which is input after the replacement with the second recording medium prior to the transfer of the shunted stream data to the second recording medium.

3. The stream data recorder of claim 2, wherein the primary recording section records, in the second recording medium, management information indicative of that the shunted stream data is reproduced prior to the stream data which is input after the replacement with the second recording medium.

4. The stream data recorder of claim 1, further comprising:
a shunted data amount holding section for holding a data amount of the shunted stream data; and
a reservation section for reserving in the second recording medium a region in which the shunted stream data is to be recorded according to the data amount held in the shunted data amount holding section,
wherein the primary recording section records stream data which is input after the replacement with the second recording medium in a region physically subsequent to the reserved region in the second recording medium.

5. The stream data recorder of claim 4, further comprising a leading address holding section for holding a leading address of the reserved region,
wherein the primary recording section starts recording of the shunted stream data from a region of the leading address.

6. The stream data recorder of claim 4, wherein the primary recording section records, in the second recording medium, management information indicative of the relationship between time information and information about relative positions with respect to a region in which a head of the shunted stream data is recorded for each predetermined unit data in the shunted stream data and the stream data which is input after the replacement with the second recording medium.

7. The stream data recorder of claim 1, wherein the primary recording section records the shunted stream data in a region at a trailing end of a free space in the second recording medium while recording the stream data which is input after the replacement with the second recording medium in a region at the leading end of the free space.

8. The stream data recorder of claim 1, wherein the transfer recording controller instructs the primary recording section to perform recording of the stream data which is input after the replacement of the first recording medium with the second recording medium and recording of the shunted stream data in parallel.

9. The stream data recorder of claim 8, wherein the primary recording section includes:
a processor for recording stream data in the first and second recording media; and
a direct access circuit for recording the shunted stream data in the second recording medium without the intervention of the processor.

10. The stream data recorder of claim 1, wherein a plurality of shunt recording media are used in a predetermined order of priority.

11. A stream data recording method for recording stream data in a recording medium, comprising the steps of:
recording stream data in a removable recording medium;
detecting that a free space of a removable first recording medium in which data is being recorded runs out;
shunting stream data input during replacement of the first recording medium with a removable second recording medium into a shunt recording medium; and
transferring the stream data shunted into the shunt recording medium to the second recording medium.

12. The stream data recording method of claim 11, wherein the step of recording the stream data includes recording, in the second recording medium, stream data which is input after the replacement with the second recording medium prior to the transfer of the shunted stream data to the second recording medium.

13. The stream data recording method of claim 12, wherein the step of recording the stream data includes recording, in the second recording medium, management information indicative of that the shunted stream data is reproduced prior to the stream data which is input after the replacement with the second recording medium.

14. The stream data recording method of claim 11, further comprising the step of reserving in the second recording medium a region in which the shunted stream data is to be recorded according to a data amount of the shunted stream data,
wherein the step of recording the stream data includes recording stream data which is input after the replacement with the second recording medium in a region physically subsequent to the reserved region in the second recording medium.

15. The stream data recording method of claim 14, further comprising the step of holding a leading address of the reserved region,
wherein the step of transferring the shunted stream data includes starting recording of the shunted stream data from a region of the leading address.

16. The stream data recording method of claim 14, wherein the step of recording the stream data includes recording, in the second recording medium, management information indicative of the relationship between time information and information about relative positions with respect to a region in which a head of the shunted stream data is recorded for each predetermined unit data in the shunted stream data and the stream data which is input after the replacement with the second recording medium.

17. The stream data recording method of claim 11, wherein the step of recording the stream data includes recording the shunted stream data in a region at a trailing end of a free space in the second recording medium while recording the stream data which is input after the replacement with the second recording medium in a region at the leading end of the free space.

18. The stream data recording method of claim 11, wherein the step of recording the stream data and the step of transferring the shunted stream data are carried out in parallel.

19. The stream data recording method of claim 18, wherein the step of recording the stream data includes:
recording stream data in the first and second recording media by a processor; and
recording the shunted stream data in the second recording medium without the intervention of the processor.

20. The stream data recording method of claim 11, wherein the step of shunting the stream data includes using a plurality of shunt recording media in a predetermined order of priority.
